(19) United States
(12) Patent Application Publication
(10) Pub. No.: US 2019/0390782 A1
(43) Pub. Date: Dec. 26, 2019

(54) Slide Valve for Controlling Fluid Flow

(71) Applicant: John R. Goetzinger, Erie, PA (US)

(72) Inventor: John R. Goetzinger, Erie, PA (US)

(21) Appl. No.: 16/018,457

(22) Filed: Jun. 26, 2018

(51) Int. Cl. F16K 11/07; F16K 37/00

(52) U.S. Cl. CPC F16K 11/0712; F16K 37/0041; F16K 11/0716

(57) ABSTRACT

A full-cavity slide valve has undercuts on both the input passageway and output passageway creating ramps to facilitate the O-rings around each of the input and output passageways to slide past without damaging the O-rings. An indicator can optionally be provided to ensure fully open and, if desired, fully closed positions are achieved.

### BACKGROUND AND SUMMARY OF THE INVENTION

The present invention is directed to the field of fluid flow control. More particularly, the present invention is directed to a non-leaking reciprocating slide valve with an undercut around the inlet passageway and outlet passageway to allow the o-rings that seal the fluid flow to be depressurized and re-pressurized as they pass by, thereby avoiding degradation of the seals. It will be understood that the term “fluid” includes both liquids as well as gases.

Innovation in valves in recent years has been restricted to ball valves and rotary valves. Very little has been done to enhance the performance of slide valves. Slide valves have been largely disfavored due to issues of leakage that restrict their usage for most applications.

It is among the objects of the present invention to provide a non-leaking, full-cavity slide valve with enhanced performance characteristics. The present invention is a valve for controlling fluid flow comprising a) a housing having an elongated cylindrical chamber extending in a first axial direction having a first internal radial dimension; b) the housing having a first inlet passageway means and first outlet passageway means extending in a second axial direction orthogonal to the first axial direction; c) a spool having i) a body portion extending in a third axial direction co-extensive with the first axial direction with an external radial dimension substantially equal to the first internal radial dimension of the passageway; ii) first circumferential seal means surrounding a first end of the spool for sealing the first end in the housing; iii) second circumferential seal means surrounding a second end of the spool for sealing the second end in the housing; iv) a lateral passageway extending through the body portion transverse to the third axial direction; d) motive means to move the spool from a first position in the housing in which the body portion, blocks fluid flow between the first inlet and the first outlet and a second position in the housing in which the lateral passageway is aligned with the first inlet and the first outlet; e) alignment means operable between the elongated cylindrical chamber and the spool maintaining proper rotational alignment of the lateral passageway with the first inlet passageway means and the first outlet passageway means.

The motive means comprises a first access port associated with the housing for attachment of fluid pressure means to a first side of the elongated cylindrical chamber and a second access port associated with the housing for attachment of fluid pressure to a second side of the elongated cylindrical chamber. Preferably, the first access port is in a first removable cap on the first end of the elongated cylindrical chamber and the second access port is in a second removable cap on the second end of the elongated cylindrical chamber. A threaded aperture is formed in a first end of the spool for allowing spool removal from the elongated cylindrical chamber in a first direction and a second threaded aperture is formed in a second end of the spool for allowing spool removal from the elongated cylindrical chamber in a second direction permitting the spool to be repaired without a need to take the valve offline.

First and second o-rings are mounted on a lateral portion of the spool surrounding a first end of the lateral passageway and a second end of the lateral passageway, respectively, the first and second o-rings sealing the first inlet passageway means and the first outlet passageway means. Third and fourth o-rings are mounted on an adjacent lateral portion of the spool surrounding the body portion which blocks fluid flow at the first inlet passageway means and the first outlet passageway means, respectively. An important aspect of the invention involves a first undercut surrounding an innermost portion of the first inlet passageway means and a second undercut surrounding an innermost portion of the first outlet passageway means to allow ease of transit by the first, second, third and fourth o-rings.

An additional feature comprises a first indicator means to verify the motive means has fully repositioned the spool to the second position in which second position in which the lateral passageway is aligned with the first inlet and the first outlet. Preferably, this indicator means comprises a visual position indicator which verifies the motive means has fully repositioned the spool. Alternatively, the indicator means comprises a reed switch indicator which verifies the motive means has fully repositioned the spool.

The alignment means comprises a threaded member with an protruding unthreaded portion mounted in the elongated cylindrical chamber, the spool having a longitudinal slot which slidingly receives the unthreaded portion preventing the spool from rotating within the elongated cylindrical chamber. Most preferably, the cylindrical chamber extends entirely through the housing and is open-ended. First and second caps are threadingly received on first and second ends of the housing to close off the cylindrical chamber. Lastly, at least one of the first and second caps captures an indicator means securing the indicator means in position at one end of the cylindrical chamber.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1 is a side view of a first embodiment of the slide valve of the present invention;

FIG. 2 is an end view of the valve shown in FIG. 1;

FIG. 3 is a cross-sectional end view as seen along line 3-3 of FIG. 1;

FIG. 4A is a cross-sectional side view as seen along line 4-4 in FIG. 2 shown in the closed position;

FIG. 4B is a cross-sectional side view as seen along line 4-4 in FIG. 2 shown in the open position;

FIG. 5A is a side view of a second embodiment of the valve body used in the slide valve of the present invention;

FIG. 5B is a top view of the second embodiment of the valve body shown in FIG. 5A;

FIG. 6 an enlarged detail view of the inlet port shown in FIG. 4B; and,

FIG. 7 is a cross-sectional side view of a second embodiment of the valve of the present invention.

### DETAILED DESCRIPTION OF THE PREFERRED EMBODIMENT(S)

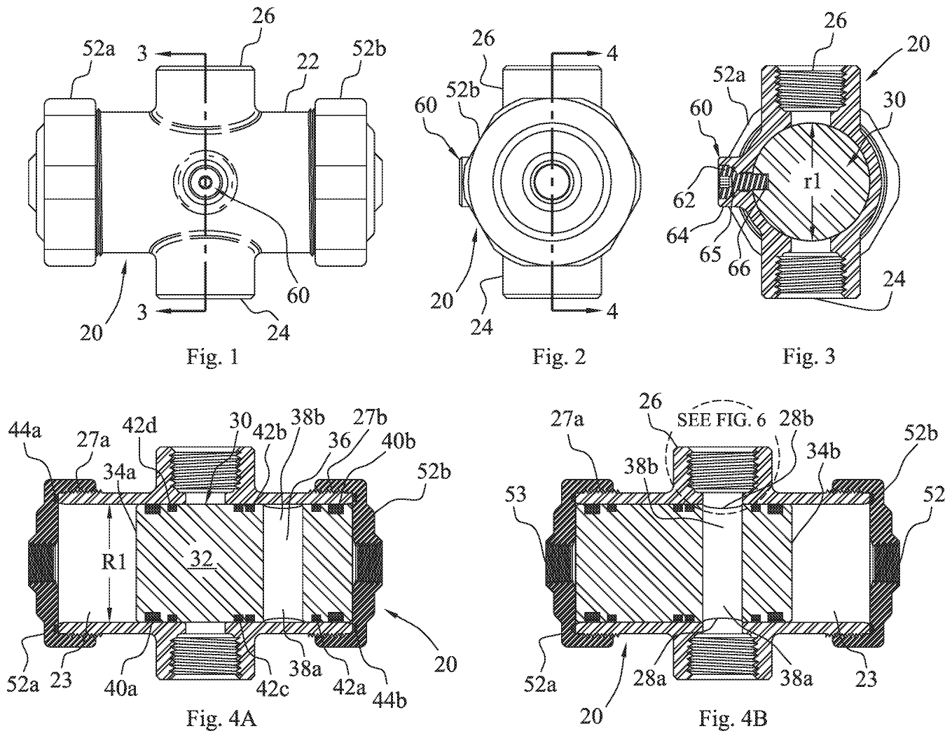

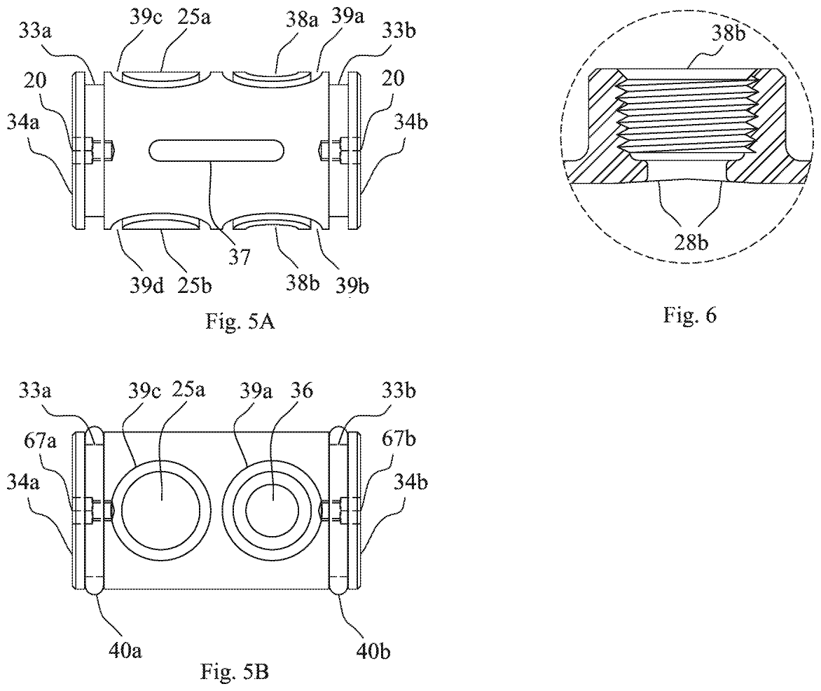

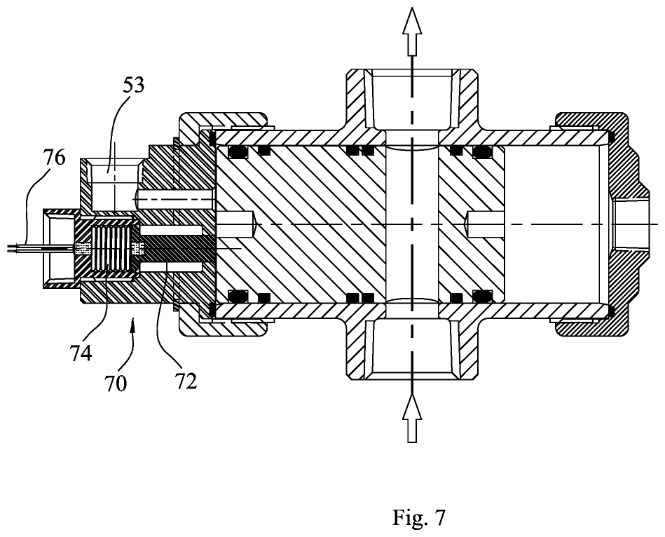

A first embodiment of the slide valve of the present invention is depicted in FIGS. 1-4B generally at 20. Slide valve 20 comprises a housing 22 having an elongated cylindrical chamber 23 extending in a first axial direction with a first internal radial dimension R₁. Housing 22 has a first inlet passageway means 24 and a first outlet passageway means 26 extending in a second axial direction orthogonal to the first axial direction. Spool 30 has a body portion 32 extending in a third axial direction co-extensive with the first axial direction and having an external radial dimension ‘r₁’ substantially equal to the first internal radial dimension of the passageway. A first circumferential seal means 40a surrounds spool 30 in groove 33a (FIG. 5A) near a first end 34a of the spool for sealing the first end in housing 22. A second circumferential seal means 40b surrounds spool 30 in groove 33b near a second end 34b for sealing the second end in housing 22.

A lateral passageway 36 extends through the body portion 32 of spool 30 transverse to the third axial direction from inlet end 38a to outlet end 38b., A first spool O-ring 42a surrounds inlet end 38a being seated in recess 39a (FIG. 5A) and second spool O-ring 42b surrounds outlet end 38b being seated in recess 39b., A third spool O-ring 42c surrounds blocking body portion 25a being seated in recess 39c, while fourth spool O-ring 42d surrounds blocking body portion 25b being seated in recess 39d. Caps 52a and 52b threadingly connect to ends 27a and 27b, respectively. Motive means is connected through access port 52 in cap 52b to move the spool 30 from a first position in the housing in which the body portion, blocks fluid flow between first inlet passageway means 24 and the first outlet passageway means 26 (FIG. 4A) and a second position in the housing in which the lateral passageway 36 is aligned with first inlet passageway means 24 and the first outlet passageway means 26. A second access port 53 is positioned in cap 52a to allow pressurized fluid to move the spool back to the blocking position. O-rings 44a and 44b are received in grooves in caps 52a and 52b fluidically sealing them against ends of housing 22.

Alignment means 60 is operable between the elongated cylindrical chamber 23 and the spool 30 maintaining proper rotational alignment of the lateral passageway 36 with the first inlet passageway means 24 and the first outlet passageway means 26. Alignment means 60 comprises a screw 62 threaded into nipple 64. O-ring 65 surrounds the head of screw 62 to inhibit leakage through nipple 64. Unthreaded portion 66 of screw 62 slides in a slot 37 (best seen in FIG. 5A) preventing rotation of spool 30 within chamber 23 which would misalign lateral passageway 36 with respect to first inlet passageway means 24 and first outlet passageway means 26. A threaded capture aperture 67a can be formed in the end 34a of spool 30 as shown in the second embodiment of the spool 30 depicted in FIGS. 5A and 5B. Similarly, a threaded aperture 67b is formed in end 34b of spool 30. Threaded apertures 67a, 67b permit the end of a complementarily threaded tool (not shown) to capture the spool 30 to remove it from housing 22 to permit replacement of O-rings 40a, 40b, 42a, 42b, 42c, 42d as becomes necessary through normal wear and tear.

It is a significant feature of the present invention that the inlet passageway means 24 and outlet passageway means 26 have undercuts that provide ramps 28a and 28b, respectively, that permit the O-rings 40a, 40b, 42a, 42b, 42c, 42d to glide past the openings 24, 26 rather than to incur what would otherwise be sharp edges that would damage/cut into those O-rings.

For certain applications, it is of critical importance that the spool 30 be fully seated in its blocking and unblocking positions. For such applications, indicator means 70 is provided at one or both ends of the housing being secured in place by end caps 52a, 52b. Plunger 72 extends into chamber 23 where it will be engaged by the first end 34a of spool 30 as spool 30 reaches the limit of its movement to open passageway 36. Plunger 72 compresses spring 74 which, in turn, when it is fully collapsed, allows current to flow through wires 76 indicating that valve 20 is fully open. A second identical indicator can be used on the opposite end to ensure valve 20 is fully closed. When the indicator 70 is used, it is provided with a lateral access port 53′ for fluid input for the motive means used to shift the spool.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

1. (canceled)

2. The valve of claim 7 wherein said motive means comprises a first access port associated with said housing for attachment of fluid pressure means to a first side of said elongated cylindrical chamber and a second access port associated with said housing for attachment of fluid pressure means to a second side of said elongated cylindrical chamber.

3. The valve of claim 2 wherein said first access port is in a first removable cap on a first end of said elongated cylindrical chamber and said second access port is in a second removable cap on a second end of said elongated cylindrical chamber.

4. The valve of claim 3 further comprising a threaded aperture in a first end of said spool for allowing spool removal from said elongated cylindrical chamber in a first direction and a second threaded aperture in a second end of said spool for allowing spool removal from said elongated cylindrical chamber in a second direction permitting said spool to be repaired without a need to take said valve offline.

5. (canceled)

6. (canceled)

7. A valve for controlling fluid flow comprising:
a) a housing having an elongated cylindrical chamber extending in a first axial direction having a first internal radial dimension;
b) said housing having a first inlet passageway means and first outlet passageway means extending in a second axial direction orthogonal to said first axial direction;
c) a spool having
i) a body portion extending in a third axial direction co-extensive with said first axial direction with an external radial dimension substantially equal to said first internal radial dimension, said body portion comprising a blocking body portion positionable within said elongated cylindrical chamber to selectively block fluid flow between said first inlet passageway means and said first outlet passageway means;
ii) first circumferential seal means surrounding a first end of said spool for sealing said first end in said housing;
iii) second circumferential seal means surrounding a second end of said spool for sealing said second end in said housing;
iv) a lateral passageway extending through said body portion adjacent said blocking body portion and transverse to said third axial direction;
d) motive means to move said spool from a first position in said housing in which said blocking body portion blocks fluid flow between said first inlet passageway means and said first outlet passageway means and a second position in said housing in which said lateral passageway is aligned with said first inlet passageway means and said first outlet passageway means;
e) alignment means operable between said elongated cylindrical chamber and said spool for maintaining proper rotational alignment of said lateral passageway with said first inlet passageway means and said first outlet passageway means;
f) first and second seals mounted on a lateral portion of said spool surrounding a first end of said lateral passageway and a second end of said lateral passageway, lateral surfaces of said first and second seals engaging and sealing said first inlet passageway means and said first outlet passageway means, respectively;
g) third and fourth seals mounted on an adjacent lateral portion of said spool surrounding said blocking body portion, each of said third and fourth seals having a lateral surface which engages and blocks fluid flow at said first inlet passageway means and said first outlet passageway means, respectively; and
h) a first undercut surrounding an innermost portion of said first inlet passageway means and a second undercut surrounding an innermost portion of said first outlet passageway means to allow ease of transit by said lateral sealing surfaces of said first, second, third and fourth seals.

8. The valve of claim 7 further comprising first indicator means to verify said motive means has fully repositioned said spool to said second position in which said lateral passageway is aligned with said first inlet passageway means and said first outlet passageway means.

9. The valve of claim 8 wherein said first indicator means comprises a visual position indicator which verifies said motive means has fully repositioned said spool.

10. The valve of claim 8 wherein said first indicator means comprises a reed switch indicator which verifies said motive means has fully repositioned said spool.

11. The valve of claim 7 wherein said alignment means comprises a threaded member with a protruding unthreaded portion mounted in said elongated cylindrical chamber, said spool having a longitudinal slot which slidingly receives said unthreaded portion preventing said spool from rotating within said elongated cylindrical chamber.

12. The valve of claim 7 wherein said cylindrical chamber extends entirely through said housing and is open-ended.

13. The valve of claim 12 further comprising first and second caps threadingly received on first and second ends of said housing to close off said cylindrical chamber.

14. The valve of claim 13 wherein at least one of said first and second caps captures an indicator means securing said indicator means in position at one end of said cylindrical chamber.

15. A slide valve for controlling fluid flow comprising:
a housing comprising:
a cylindrical chamber having an internal radial dimension,
an inlet passageway extending into a lateral side of said cylindrical chamber, and
and an outlet passageway extending out of a lateral side of said cylindrical chamber;
a spool positioned in said cylindrical chamber, said spool comprising:
a body portion having an external radial dimension substantially equal to said internal radial dimension of said cylindrical chamber, said body portion comprising a blocking body portion that closes said valve when positioned between said inlet passageway and said outlet passageway, and
a fluid passageway extending through said body portion adjacent said blocking body portion that opens said valve when aligned with said inlet passageway and said outlet passageway;
a first seal and a second seal mounted on said spool surrounding said fluid passageway to engage and seal said inlet passageway and said outlet passageway, respectively; and
a third seal and a fourth seal mounted on said spool surrounding said blocking body portion to engage and block said inlet passageway and said outlet passageway, respectively.

16. The slide valve for controlling fluid flow of claim 15 wherein said first, second, third, and fourth seals comprise respectively a first, second, third, and fourth o-ring; and
further comprising a first undercut surrounding an innermost portion of said inlet passageway and a second undercut surrounding an innermost portion of said outlet passageway to allow ease of transit by said first, second, third and fourth o-rings.

17. The slide valve for controlling fluid flow of claim 15 further comprising:
motive means to move said spool from a first position in said housing in which said blocking body portion blocks fluid flow between said inlet passageway and said outlet passageway and a second position in said housing in which said fluid passageway is aligned with said inlet passageway and said outlet passageway; and
alignment means operable between said cylindrical chamber and said spool for maintaining proper rotational alignment of said fluid passageway with said inlet passageway and said outlet passageway.

18. The slide valve for controlling fluid flow of claim 17 further comprising:
a first circumferential seal surrounding a first end of said spool for sealing said first end in said housing; and
a second circumferential seal surrounding a second end of said spool for sealing said second end in said housing; and
wherein said motive means comprises a first access port associated with said housing for attachment of fluid pressure means to a first side of said cylindrical chamber and a second access port associated with said housing for attachment of fluid pressure means to a second side of said cylindrical chamber.

19. A valve for controlling fluid flow comprising:
a housing having an elongated cylindrical chamber extending in a first axial direction having an internal radial dimension, said housing having an inlet passageway and an outlet passageway extending in a second axial direction orthogonal to said first axial direction;
a spool comprising:
a body portion extending in a third axial direction co-extensive with said first axial direction with an external radial dimension substantially equal to said internal radial dimension of said elongated cylindrical chamber, said body portion comprising a blocking body portion positionable within said elongated cylindrical chamber to selectively block fluid flow between said inlet passageway and said outlet passageway; and
a lateral passageway extending through said body portion adjacent said blocking body portion and transverse to said third axial direction;
motive means to move said spool from a first position in said housing in which said blocking body portion blocks fluid flow between said inlet passageway and said outlet passageway and a second position in said housing in which said lateral passageway is aligned with said inlet passageway and said outlet passageway;
a first seal and a second seal mounted on said spool around said lateral passageway, said first seal and said second seal respectively sealing around said inlet passageway and said outlet passageway when said valve is open;
a third seal and a fourth seal mounted on said spool around said blocking body portion, said third seal and said fourth seal respectively sealing around said inlet passageway and said outlet passageway when said valve is closed; and
a first undercut surrounding an innermost portion of said inlet passageway and a second undercut surrounding an innermost portion of said outlet passageway to allow ease of transit by said first, second, third and fourth seals.

20. The valve for controlling fluid flow of claim 19 wherein said first, second, third, and fourth seals comprise respectively a first, second, third, and fourth o-ring.

21. The valve for controlling fluid flow of claim 19 further comprising:
alignment means operable between said elongated cylindrical chamber and said spool for maintaining proper rotational alignment of said lateral passageway with said inlet passageway and said outlet passageway;
a first circumferential seal surrounding a first end of said spool for sealing said first end in said housing; and
a second circumferential seal surrounding a second end of said spool for sealing said second end in said housing.

22. The valve for controlling fluid flow of claim 21 wherein said motive means comprises a first access port associated with said housing for attachment of fluid pressure means to a first end of said elongated cylindrical chamber and a second access port associated with said housing for attachment of fluid pressure means to a second end of said elongated cylindrical chamber; and
further wherein said first access port is in a first removable cap on said first end of said elongated cylindrical chamber and said second access port is in a second removable cap on said second end of said elongated cylindrical chamber.

23. The valve for controlling fluid flow of claim 19 further comprising:
an indicator means to verify said motive means has fully repositioned said spool to said second position in which said lateral passageway is aligned with said inlet passageway and said outlet passageway; and
a first end cap and a second end cap threadingly received on a respective first end and second end of said elongated cylindrical chamber, at least one of said first and second end caps capturing said indicator means securing said indicator means in position at one end of said elongated cylindrical chamber.
